(19) United States
(12) Patent Application Publication
(10) Pub. No.: US 2019/0002781 A1
(43) Pub. Date: Jan. 3, 2019

(54) MEANS OF PROCESSING BIOMASS FOR USE IN INTERNAL COMBUSTION ENGINES

(71) Applicant: Roger Swenson, Salt Lake City, UT (US)

(72) Inventor: Roger Swenson, Salt Lake City, UT (US)

(21) Appl. No.: 15/637,582

(22) Filed: Jun. 29, 2017

(51) Int. Cl. C10L 1/32; F01K 23/10; F02B 45/10; C05D 1/00; C05D 9/00

(52) U.S. Cl. CPC C10L 1/324; F01K 23/10; F02B 45/10; C10L 2290/545; C05D 9/00; C10L 2250/06; C10L 2290/28; C05D 1/00

(57) ABSTRACT

Biomass is processed into a slurry (Heavy Biofuel Oil or HBFO) comprising a fuel slurry suitable for low and medium speed diesel engines or other suitable power equipment that is produced by subjecting biomass feedstock to steam explosion processing, washing and separating unwanted materials, micronization to a targeted size, de-ashing with high pressure steam combined with micronization, and separation by means of classification of unwanted materials and a slurrification processes to make the HBFO suitable for use in internal combustion engines, such as diesel engine systems.

### BACKGROUND OF THE INVENTION

### Field of the Invention

The present invention relates generally to the field of biomass fuel preparation and processes. More specifically, the present invention relates to modifications of biomass processing for the production of a form of biofuel that has characteristics that will allow it to be used as a diesel engine fuel. The present invention also relates generally to the use of this new formulation of biomass fuel for the production of energy in diesel engine generation systems that typically use liquid or gaseous hydrocarbon fuels.

### Description of the Related Art

Biomass is a natural carbonaceous material produced in nature from the absorption of CO2 and conversion to plant matter using solar energy in a complex photosynthesis process. Biomass has been used as a fuel and as shown in Prior Art FIG. 1, biofuels are produced through multiple pathways including pelletizing, pyrolysis to char products and bio-oils as well as fermentation to ethanol or similar hydrocarbon products. These various products can be used in applications such as thermal energy production, chemical production and in some manner fractional distillation for high value transportation fuels displacing gasoline. Solid carbon fuels generally produced in the form of pellets or briquets have been produced in recent times to displace coal in large scale boiler systems for environmental reasons. Many biomass conversion systems were constructed to use biomass waste products from wood mills directly in boiler systems to generate power with steam and that power received premium prices as renewable power supplies.

The systems that used biomass directly in steam boilers are very inefficient when compared to modern natural gas fired power systems and find it difficult to economically operate on a competitive basis. Other renewable technologies such as wind and solar energy have seen dramatic price reductions making the biomass based steam generation plants uneconomic to continue to operate based on competing with those technologies to meet renewable power generation quantity targets. Plants have closed causing large quantities of biomass to be available in many areas and much research has been done to find acceptable economic uses for such material. The ongoing research has spurred the development of new processes that have been developed have focused on creating new forms of biomass processing to develop a wider application base for biomass as an input material for higher value use. Many processes were developed to convert the biomass based fuels for use as transportation fuels to displace gasoline in high speed engines or other applications involving high degrees of complex systems to process the biomass into more usage forms.

One form of biomass treatment called steam explosion was first patented in 1926 by Mason et al. The patent shows a form of biomass treatment involving steam treatment where wood chips are fed into a specialized system and steam is applied for a period of time at appropriate pressures to saturate the material and then the steam is allowed to escape very quickly in essence creating the steam explosion effect. The biomass is then rendered into a form of pulp. The rapid decompression of the biomass material causes a rupture of the material's rigid fibers. The rupturing of the rigid fibers opens up the cellulose bundles, and this result in a better accessibility of the cellulose for processing such as with enzymatic hydrolysis and fermentation. It is known that depending on residence time and pressures and temperatures the biomass is exposed to, steam explosion can result in anything from small cracks in the wood structure, to total defibrillation of the wood fibers. It is also known that substances such as acetic acid is released from the wood, and this result in partial hydrolysis of the cell wall components. It has been shown that the use of diluted acids (i.e. sulfuric or nitric acid) can accelerate the process i.e. result in higher hydrolysis rates.

Steam explosion of biomass can be used as a pulping process, as pre-treatment for bioethanol or biogas production. It is also used for the pre-treatment of biomass prior to pelletization that can increase the heating value, bonding properties and hydrophobicity of the wood. It has been determined that steam explosion treatment reduces the amount of alkali metals in the biomass. Steam explosion turns biomass from a tenacious flexible material into a brittle rigid material. This behavior is interesting since the mechanical properties of biomass are often limiting its utilization and this property allows biomass material to be further processed to a finer particle basis as can be required for some applications.

Biomass materials and their elemental make-up that must be considered for fuels production vary substantially based on species and even vary based on harvest methods. The considerations for fuels are based on elements within the biomass that can cause issues with wear from fuel injection or other internal systems and from fouling and depositions post combustion. The wear issues in general can be caused by hard impurities such as dirt or sand entrained in bark or on surfaces of biomass. The elements within biomass that can cause post combustion issues are generally alkali metals that naturally occur in biomass varieties at different levels depending on the species of biomass. Also, chlorine exists in biomass and the chlorine can form low melting point materials when it combines with some metals. Silica also represents a potential wear issue as biomass generally has considerable amounts of silicon present.

The cause of fouling deposit formation on boiler surfaces include condensation of inorganic vapors, inertial impaction and sticking of particles, thermophoresis and chemical reaction. How these deposits occur and the rates of deposition, are important to the morphology and mechanical properties of the deposits. There are three principal undesirable effects of deposits: 1) deposits retard the heat transfer and lead to an eventual decline in system efficiency and capacity if they cannot be removed according to the design assumptions for the combustion system 2) deposits can grow to the extent that flow through the exhaust system is restricted and potentially causing mechanical damage, and 3) deposits are associated with corrosion. Deposits which are less tenacious and easily removed (e.g., by soot blowing), represent less of a problem to facility operators than those which are hard to remove, and require shutting down the system for cleaning.

Alkali and alkaline earth metals in the fuel ash are important to the formation of deposits. For biomass, potassium is the major alkali element of concern. Both potassium and calcium are important in the formation of sulfate deposits on system surfaces. Straws, other grasses and herbaceous species, younger tissues of woody species, nut hulls and shells, and other annual biomass contain about 1% potassium dry weight. Along with potassium, straw contains a substantial amount of chlorine, usually at levels greater than 0.2% and up to 3% dry weight. Straw also contains substantial amounts of silica. Rice straw, for example, contains about 10% of dry weight as silica. By itself, silica does not present much of a problem for biomass boilers. Rice hull, which may contain 20% by weight silica, does not easily slag and foul in boilers when fired alone because the ash is relatively pure in silica (>95% SiO2 in ash, typically) and the melting point is high (>1650° C). Silica in combination with alkali and alkaline earth metals can lead to the formation of low melting point compounds which readily slag and foul at normal biomass boiler furnace temperatures (800° C.-900° C). Chlorine can be an important facilitator in fouling, leading to the condensation of alkali chlorides on heat transfer surfaces in the boiler, and promoting the development of alkali sulfates. Chlorine may be an important element in the vaporization of alkali species. Sugar cane bagasse, which has long been used successfully as boiler fuel, and which is derived from another high potassium, high silica herbaceous crop, does not exhibit the same fouling tendencies as straw and sugar cane trash (tops and leaves) because both potassium and chlorine are substantially leached from the fuel in the process of extracting sugar.

Wood based biomass contain less silicon than grass and crops and the mature stem wood that makes up the majority of wood fuel, including urban wood fuel. Wood also contains substantially lower amounts of potassium, usually only about 0.1% dry weight. Potassium is a highly mobile element in plants, and moves to younger, actively developing tissues, leaving the mature stem wood depleted in potassium. Combustion of the leaf and branch fractions of wood, or coppice materials from short rotation woody cultures (SRWC), will also encounter higher levels of potassium (as well as nitrogen and sulfur) in the fuel. This is already apparent in the agricultural wood fuels (e.g. annual prunings) currently burned in boilers. Although wood fuels are inherently low in silica, adventitious material such as clays and other soil components brought in with the fuel include silica and can lead to fouling, although usually at reduced rates compared to straw. Urban wood fuels can include substantial amounts of adventitious materials from manufactured products.

The chemistry of inorganic transformations in the combustion process is quite complex, involving multiple physicochemical pathways among alkali, alkaline earth, and other inorganic and organic species in the fuel. The principal components of interest include silicon, potassium, chlorine, sulfur, iron, phosphorus, magnesium, calcium, titanium, carbon, hydrogen, and oxygen. Sodium and aluminum, which are not normally found in inherently high concentrations, may be introduced as soil or through prior processing operations and may also influence the fouling behavior. For most biomass fuels, the elements silicon, potassium, calcium, chlorine, sulfur, and to some extent, phosphorus, appear to be the principal elements involved in the fouling of system surfaces.

Silicon can represent a large share of the non-carbon elements in biomass. The silicon component varies between species of biomass and even from different components of the harvested biomass such as leaves, stems, bark or trucks of wood species. Silicon is found as a silica hydrate form and has been generally observed in a size below 5 microns but in some can be larger size form. Beyond issues with deposition after combustion there are also concerns of abrasion in areas that involve high flow rates such as fuel injection systems or sliding surfaces in close tolerance such as in piston operation in engines. Removing silicon from the systems will reduce such issues but issues can also be minimized to acceptable levels if the particle size is reduced such that abrasion can be reduced.

Consequently, biomass feedstocks to produce fuels have elements that can negatively affect equipment and those elements vary substantially among sources. Their composition and quantity primarily depend on (1) the type of feedstock, (2) harvesting methods and contamination that occurs during that step, and (3) the processing to usable fuel from additives or milling.

Various combustion technologies have been developed to overcome the combustion issues with biomass fuels. Specially designed combustion systems include fluidized bed combustion, pyrolysis/gasification systems, and low heat capacity furnaces (ie. without heat absorption surfaces). In general, these systems are cumbersome, expensive, and can require very large obtrusive structures.

The prior art discloses technologies to process biomass to more readily grind and open the biomass cellular structure to improve processing for various outcomes. However, the quality of the traditional biomass used in these fuel mixtures normally limits (1) the particle size distribution of the solids and (2) the degree of combustion (ie. carbon burnout) and (3) issues associated with elements that are detrimental to engine based energy conversion. The prior art has not addressed the specific impurity removal system and processes to deal with issues associated with producing biomass fuels with specific requirements for use in diesel engine systems. Some disclosure suggests using biomass that has been processed to a char based material and ground to mix with additives and then suggest that this material can be suitable for engine use some disclosures even suggest the need for a de-ashing step, however they do not suggest a means to perform such a step.

What is also important to consider rigorously is the guidelines for fuel specifications published by diesel engine equipment manufacturing companies to protect engine systems. MAN B&W is one diesel engine technology company that provides a Guideline for Biofuel specifications and it is shown in Table 1. It is clear that with the wide variations in biomass components that must be dealt with, a very flexible system to remove unwanted materials in the original biomass is required to meet such standards.

TABLE 12
Guiding Biofuel Specifications for MAN B&W Two-stroke
Low Speed Diesel Engines

Ash .15%
Sulfur 5%
Vanadium 600 ppm (m/m)
Aluminum + Silicon 80 mg/kg
Sodium + potassium 200 ppm
Calcium 200 ppm

Diesel engine systems have requirements for low levels of contaminants that form abrasive ashes such as aluminum and silicon to the degree that the combination of such metals are not greater than 80 ppm by weight in the liquid fuel prior to centrifugal separators reducing these impurities to an acceptable level and 18 ppm after centrifugal separators have been employed. Biomass fuels have a wide range of impurities including chlorine, sulfur and metals (potassium, calcium, silicon, aluminum, etc.) and diesel engines have set specifications to reduce those impurities to very low levels or process the biomass in a way to eliminate unwanted issues from those impurities.

Table 1 shows the guidelines provided by one major diesel engine technology company for specifications regarding fuel impurities.

### SUMMARY

From the foregoing discussion, it should be apparent that a need exists for a means of removing contaminants from biomass to use as a diesel engine-based fuel. Beneficially, such a means would process biomass such that it is usable for some of the same applications that are applicable to lighter hydrocarbons, including powering internal combustion engines such as low speed and medium speed 2-stroke diesel engine systems and specialized turbine systems.

The present invention has been developed in response to the present state of the art, and in particular, in response to the problems and needs in the art that have not yet been fully solved by currently available inventions. Accordingly, the present invention has been developed to provide a method of producing biomass-based liquefied processed carbon (“Heavy Biofuel or HBFO) from biomass materials, the steps of the method comprising: de-ashing the biomass to reduce an alkali metals and chlorine content using a steam explosion process; steam jet mill micronizing the resulting processed biomass such that additional materials are removed resulting in particles having an average size of less than 20 microns in size; classifying the material by separation and removing larger harder unwanted materials; and slurrying the processed biomass with water and hydrocarbon fuels to form a stable micro-fluid meeting diesel engine technology company criteria including meeting an apparent equivalent Newtonian fluid viscosity of between 10 and 20centiStokes.

The method may further comprise: milling a unit of biomass material using one or more milling units adapted to micronize the biomass with steam jet mills; washing the biomass material and repeatedly milling the biomass material with a steam jet mill to reduce the prevalence of one or more alkali metals in the unit of biomass; and classifying the micronized material and extracting the larger and harder biomass in the biomass material, the larger and harder biomass made up of a higher portion of silica and alumina.

The method may further comprise repeatedly steam jet milling the biomass material until the prevalence of silicon and aluminum is below 80 PPM and the prevalence of calcium is below 400 PPM before slurry preparation.

The method, in some embodiments, may further comprise repeatedly steam jet milling the biomass material until the prevalence of silicon and aluminum is below 18 PPM and the prevalence of calcium is below 200 PPM before slurry preparation.

The method may also further comprise repeatedly steam jet milling the biomass material until the prevalence of silicon and aluminum is below 80 PPM and the prevalence of calcium is below 200 PPM in the resulting slurry fuel.

The method may likewise further comprising repeatedly steam jet milling the biomass material until the prevalence of silicon and aluminum is below 18 PPM and the prevalence of calcium is below 200 PPM in the resulting slurry fuel.

In various embodiments, the biomass material removed by classification may be sent to a combustion system to be used as fuel to create steam for use in all of: the steam jet mill process, the water purification production process, and power generation with steam produced.

The biomass material removed by classification may be sent to a combustion system to be used as fuel to create steam for use in all of: the steam jet mill process, the water purification production process, and power generation with steam produced.

The biomass material removed by classification may be sent to a combustion system to be used as fuel to create steam for use in all of: the steam jet mill process, the water purification production process, and power generation with steam produced.

The method of claim 3, wherein the biomass material removed by classification is sent to a combustion system to be used as fuel to create steam for use in all of: the steam jet mill process, the water purification production process, and power generation with steam produced.

The biomass material may be removed by during processing is used to produce fertilizer.

It is an object of the present invention to provide a biomass based fuel that is able to (1) achieve acceptable combustion characteristics in internal combustion engine systems, (2) sufficiently reduce the abrasive impurities such as alkali metals and other ash forming elements to levels that are not harmful to the engine system, and (3) utilize existing biomass steam explosion technology processes with added novel elements to eliminate contaminants to some degree prior to or during milling with additional biomass fuel production cleaning systems that are available to enable economic production of biomass fuel acceptable as a fuel for internal combustion engines.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 sets forth a block diagram showing the typical biomass processing paths to produce a biofuel formulation by existing process in accordance with the present invention;

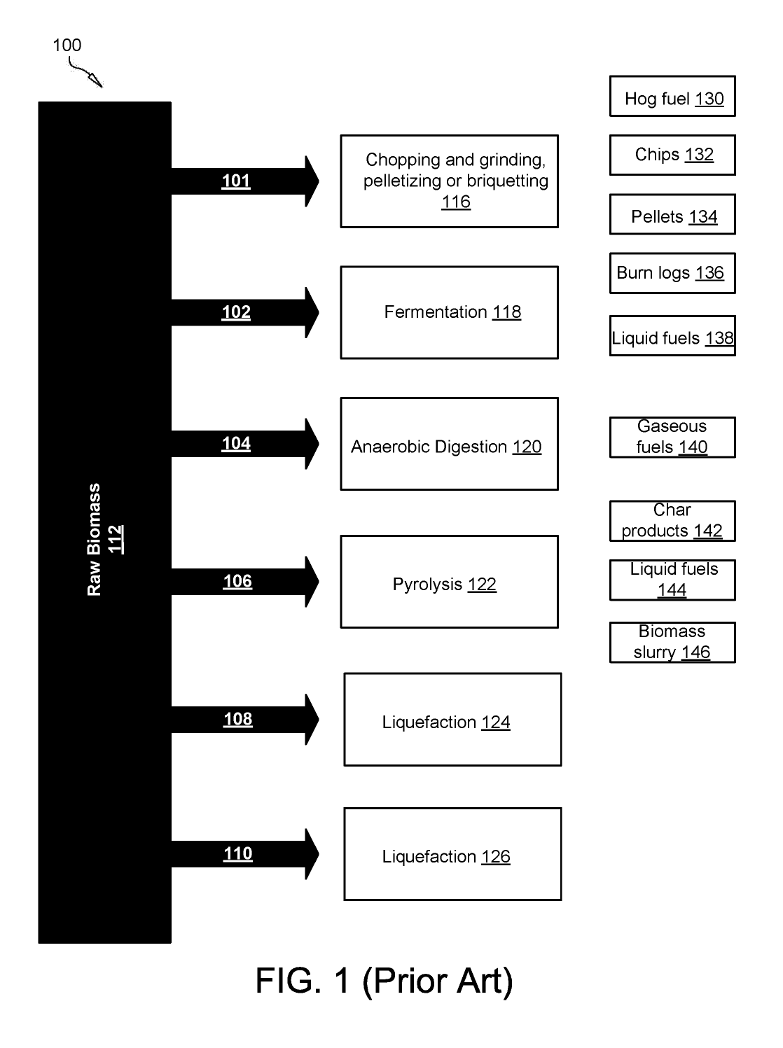

FIG. 2 sets forth a basic process flow diagram of a method of biomass processing treatment for producing a diesel engine fuel grade bio-fuel for fuel for diesel systems in accordance with the present invention;

FIG. 3 sets forth a basic process flow diagram of a method of biomass processing treatment production with a milling step to an intermediate size and then washed to remove soluble materials followed by additional treatment to create diesel engine fuel grade biomass for creating a slurry for fueling diesel engine systems in accordance with the present invention;

FIG. 4 sets forth a basic process flow diagram of a method of biomass based diesel fuel production with extracted components that will contain high ash levels being directed to a combustion system to produce steam or power for processing and purified water or power to create biomass based liquefied processed carbon slurry fuel in accordance with the present invention; and

FIG. 5 sets forth a basic process flow diagram of a method of biomass based diesel fuel production with extracted components that will contain high ash levels being directed to produce a fertilizer product from the extracted elements from the process used to create biomass based liquefied processed carbon slurry fuel in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Appearances of the phrases “in one embodiment,” “in an embodiment,” and similar language throughout this specification may, but do not necessarily, all refer to the same embodiment.

The described features, structures, or characteristics of the invention may be combined in any suitable manner in one or more embodiments. In the following description, numerous specific details are provided. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

It is an objective of the present invention to successfully address the problems associated with traditional biomass as fuel for internal combustion engines and some forms of turbine generation systems. The present invention provides modifications in the steam explosion biomass processing that conditions biomass by adding a steam jet processing additional step to continue removing the contaminants that are water soluble or susceptible to extraction from the steam conditions to acceptable levels prior to the final biomass refining process and in addition utilizing the steam jet process to micronize such processed biomass such that said fuel grade biomass can mixed with liquid elements and create a slurry suitable for the fuel delivery system and operation of a diesel engine.

A process that reduces quantities of certain elements inherent in biomass that lead to abrasive ash such as silicon oxides (silicates) or aluminum oxides and calcium compounds to acceptable levels in the fuel grade biomass after the biomass has been processed in the steam explosion system and the micronization of such processed biomass with a size particle separation system to remove abrasive or fouling impurities targeted for extraction and production of a slurry with said micronized biomass using well know commercially available slurry processes.

A process that uses materials extracted during the biomass refining process and uses those extracted materials in a product or in a process to create additional value or reduce material waste from said processing. Such processes would produce a biomass based fuel product that would be capable of use in a diesel engine or specialized turbine with acceptable wear characteristics. These and other aspects of the present invention are realized in a method and system for producing biomass based fuels as shown and described in the following figures and related description.

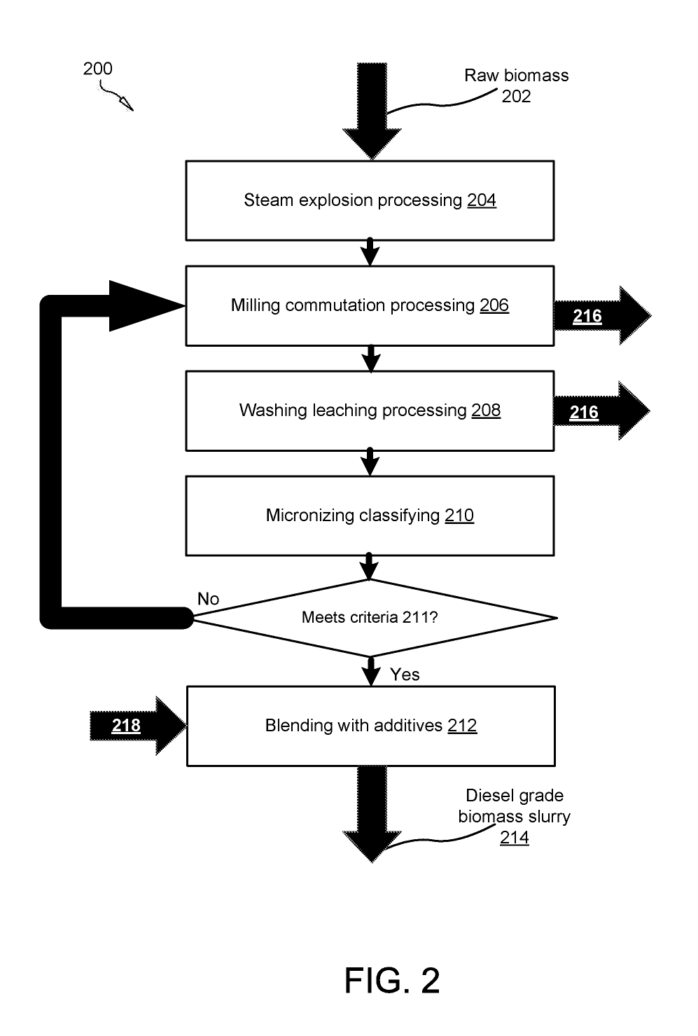

FIG. 2 sets forth a basic process flow diagram for key steps of a method of biomass treatment for biomass feedstock to create diesel engine fuel grade biomass fuel for fuel for diesel engine systems. FIG. 2 shows suitable raw biomass input 202 to a steam explosion process 204. That steam exploded material is then milled 206 using a steam jet to a set level and subjected then washed with such steam jet in 208 to remove any soluble material exposed from the milling process in 206. The milled material is subjected to a classification system involving a fluidic (air or flotation) or electrostatic separation system to separate larger particles and any remaining particles that contain a high percentage of unwanted abrasive or fouling material 210. The biomass material is then tested 211 for conformity to a set criteria. If some portion of the classified biomass material does not satisfy the criteria it is returned to 206 for further processing and if any of the biomass meets the criteria it is sent to the slurry production step 212 for mixing to produce the stable biomass based diesel fuel in 214.

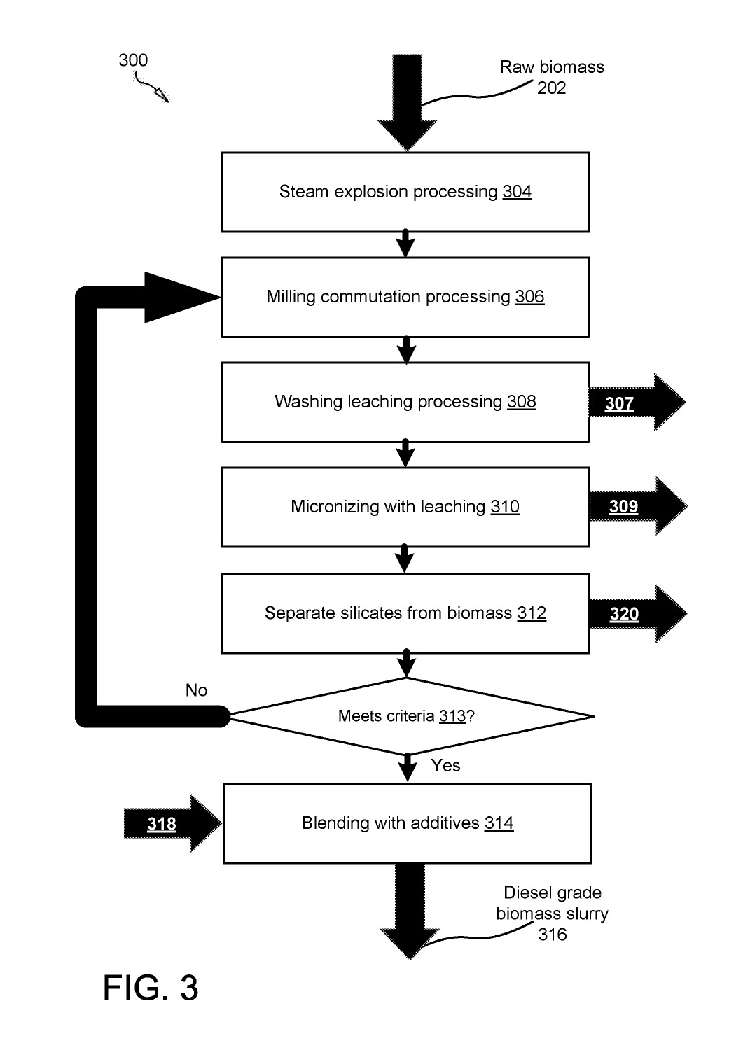

FIG. 3 sets forth a basic process flow diagram of a method of biomass treatment for biomass feedstock to create diesel engine fuel grade biomass fuel for fuel for diesel engine systems. FIG. 3 comprises suitable raw biomass input 302 to a steam explosion process 304. That steam exploded material is then milled using a steam jet to a set level 306 and subjected then washed in a separate step 308 to remove unwanted particles that could damage engine systems. Unwanted material from such wash is removed at 307. That processed biomass material is then milled using a steam jet to a set level 310 and subjected then washed with steam jet in 312 to remove any soluble material exposed from the milling process at 310 and the subjected material at the same time is exposed to the steam jet and any unwanted material is removed at 309. In 312, the material from the milling and cleaning process in 310 is subjected to a classification system (or step) or an electrostatic separation to separate unwanted particles remaining or particles which contain a high percentage of harder abrasive or potentially fouling material 312 and such unwanted material is removed from the processing at 320. The remaining biomass material is then tested 313 for conformity to a set criteria and if it does not meet the criteria it is returned to 310 for further processing and if the biomass meets the criteria it is sent to the slurry production step 314 for mixing with blending inputs 318 to produce the stable biomass based diesel fuel in 316.

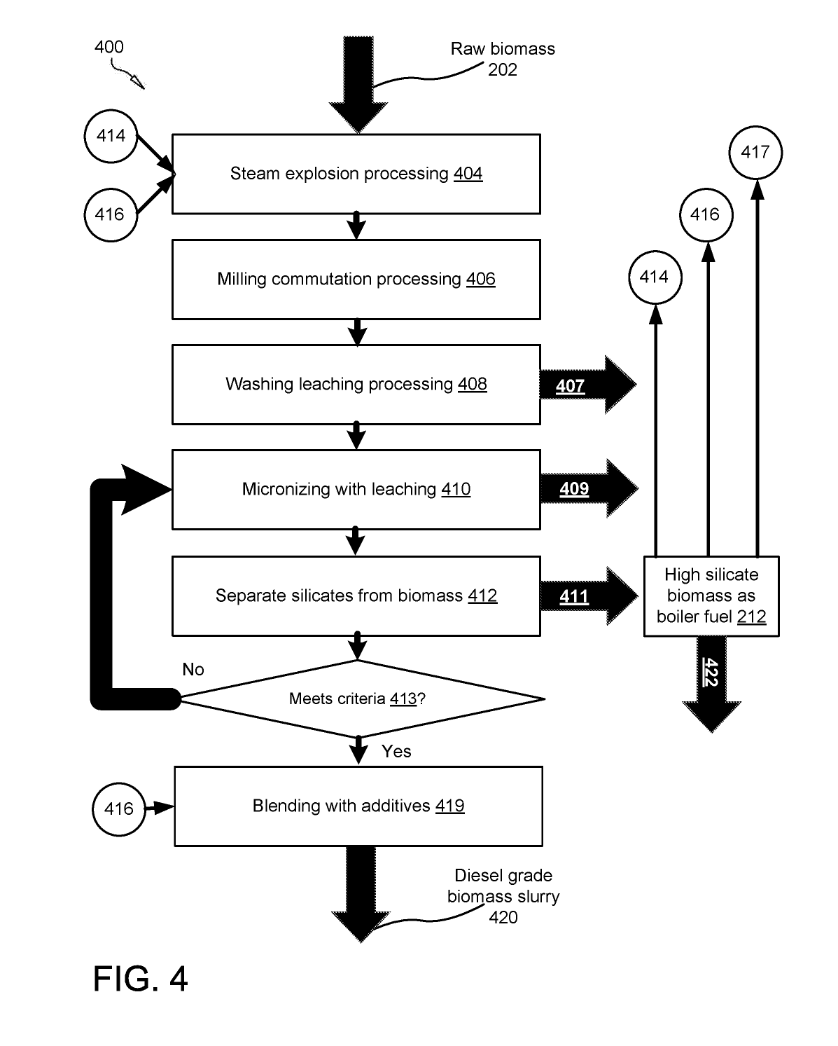

FIG. 4 sets forth a basic process flow diagram of a method of biomass treatment for biomass feedstock to create diesel engine fuel grade biomass fuel for fuel for diesel engine systems. FIG. 4 comprises suitable raw biomass input 402 to a steam explosion process 404. That steam exploded material is then milled using a steam jet to a set level 406 and subjected then washed in a separate step 408 to remove hard particle that could impede micronization.

Biomass material remaining is then milled using a steam jet to a set level 410 and subjected then washed with steam jet with unwanted material extracted at 409. In 412 the milled and cleaned material is subjected to a size classification separation system or to an electrostatic separation system to separate any particles remaining that contain a high percentage of harder abrasive or potentially fouling material 412. Any materials removed in processes steps shown at 407, 409, and 411 are directed to a combustion system to produce steam 414 and 416, purified water 416 or power 417 as shown as 414, 416 and 417 as directed to other input point in the production process. The biomass material is then test for conformity to a set criteria and if it does not meet the criteria it is returned to 410 for further processing and if the biomass meets the criteria it is sent to the slurry production step 419 for mixing with suitable blending components at 416 to produce the stable biomass based diesel fuel in 420.

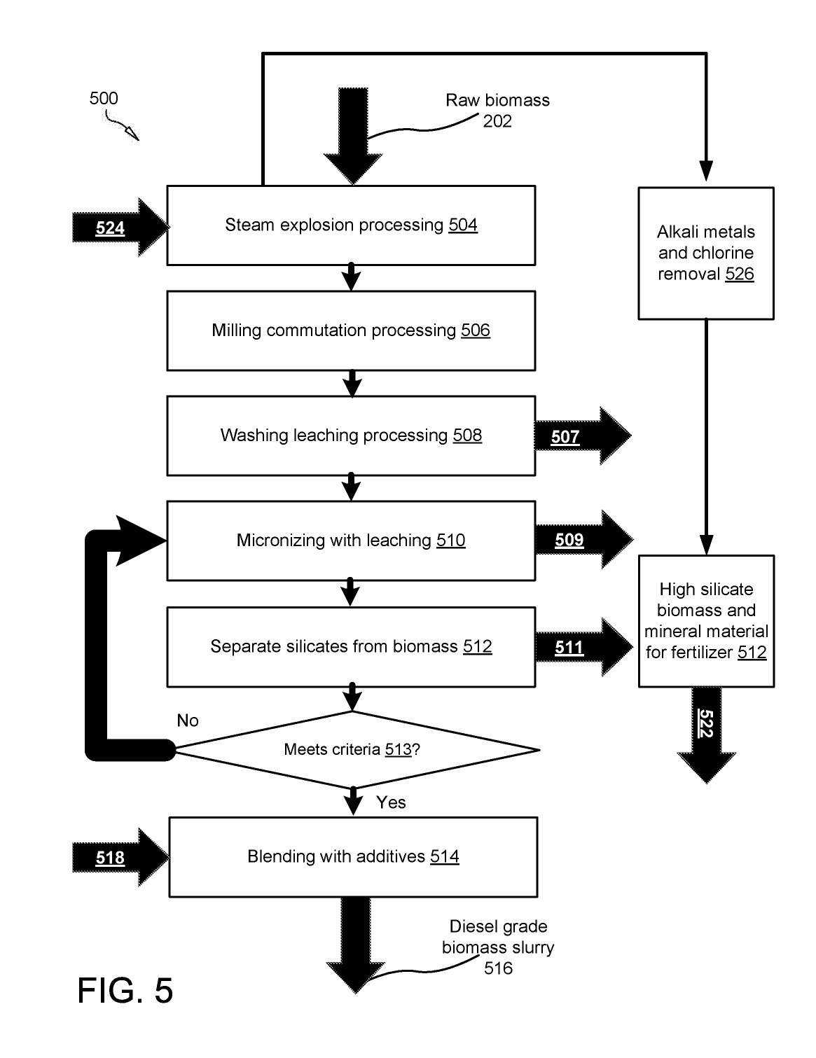

FIG. 5 shows the same biomass processing steps as FIG. 4 but the materials removed from the biomass in some or all stages of material separation at 507, 509, 526 and go to a process to create a fertilizer material at 522.

In some embodiments, fuel injectors are replaced or retrofit with units designed to handle the volume of biofuel slurry required to combust the amount of thermal energy the engine was designed for the thermal energy equivalent of the gaseous fuel, distillate oil or heavy fuel oil the engine was designed for combusting to maintain the same mechanical power output.

In some embodiments, common rail injection components are replaced or retrofit which are designed to handle the volume of biofuel slurry fuel required to be injected to provide the thermal energy equivalent of the distillate oil or heavy fuel of the engine or turbine was designed for combusting to maintain the same mechanical power output.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of producing biomass-based liquefied processed carbon (“Heavy Biofuel or HBFO) from biomass materials, the steps of the method comprising:
de-ashing the biomass to reduce an alkali metals and chlorine content using a steam explosion process;
steam jet mill micronizing the resulting processed biomass such that additional materials are removed resulting in particles having an average size of less than 20 microns in size;
classifying the material by separation and removing larger harder unwanted materials; and
slurrying the processed biomass with water and hydrocarbon fuels to form a stable micro-fluid meeting diesel engine technology company criteria including meeting an apparent equivalent Newtonian fluid viscosity of between 10 and 20 centiStokes.

2. The method of claim 1, further comprising:
milling a unit of biomass material using one or more milling units adapted to micronize the biomass with steam jet mills;
washing the biomass material and repeatedly milling the biomass material with a steam jet mill to reduce the prevalence of one or more alkali metals in the unit of biomass; and
classifying the micronized material and extracting the larger and harder biomass in the biomass material, the larger and harder biomass made up of a higher portion of silica and alumina.

3. The method of claim 1, further comprising repeatedly steam jet milling the biomass material until the prevalence of silicon and aluminum is below 80 PPM and the prevalence of calcium is below 400 PPM before slurry preparation.

4. The method of claim 1, further comprising repeatedly steam jet milling the biomass material until the prevalence of silicon and aluminum is below 18 PPM and the prevalence of calcium is below 200 PPM before slurry preparation.

5. The method of claim 2, further comprising repeatedly steam jet milling the biomass material until the prevalence of silicon and aluminum is below 80 PPM and the prevalence of calcium is below 200 PPM in the resulting slurry fuel.

6. The method of claim 2, further comprising repeatedly steam jet milling the biomass material until the prevalence of silicon and aluminum is below 18 PPM and the prevalence of calcium is below 200 PPM in the resulting slurry fuel.

7. The method of claim 3, wherein the biomass material removed by classification is sent to a combustion system to be used as fuel to create steam for use in all of: the steam jet mill process, the water purification production process, and power generation with steam produced.

8. The method of claim 4, wherein the biomass material removed by classification is sent to a combustion system to be used as fuel to create steam for use in all of: the steam jet mill process, the water purification production process, and power generation with steam produced.

9. The method of claim 5, wherein the biomass material removed by classification is sent to a combustion system to be used as fuel to create steam for use in all of: the steam jet mill process, the water purification production process, and power generation with steam produced.

10. The method of claim 3, wherein the biomass material removed by classification is sent to a combustion system to be used as fuel to create steam for use in all of: the steam jet mill process, the water purification production process, and power generation with steam produced.

11. The method of claim 3, wherein the biomass material removed by during processing is used to produce fertilizer.

12. The method of claim 4, wherein the biomass material removed during processing is used to produce fertilizer.

13. The method of claim 5, wherein the biomass material removed during processing is used to produce fertilizer.

14. The method of claim 6, wherein the biomass material removed during processing is used to produce fertilizer.
